(19) United States
(12) Patent Application Publication
(10) Pub. No.: US 2024/0413974 A1
(43) Pub. Date: Dec. 12, 2024

(54) DYNAMIC RUNTIME CONFIGURE SYSTEM FOR BITCOIN MINING SYSTEMS TO IMPROVE SYSTEM PERFORMANCE AND COMPLIANCE WITH ENERGY PROVIDERS

(71) Applicant: Auradine, Inc., Santa Clara, CA (US)

(72) Inventors: Saptadeep PAL, Cupertino, CA (US); Patrick XU, Saratoga, CA (US); David CARLSON, Haslet, TX (US); Nicholas CABI, San Jose, CA (US); Aditya BATRA, Saratoga, CA (US); Raju RAKHA, Santa Clara, CA (US); Barun KAR, Saratoga, CA (US); Rajiv KHEMANI, Los Altos Hills, CA (US); Robert ASHLEY, San Jose, CA (US); Matthew TOMEI, Los Angeles, CA (US); Sridhar CHIRRAVURI, Sunnyvale, CA (US)

(21) Appl. No.: 18/737,917

(22) Filed: Jun. 7, 2024

Related U.S. Application Data
(60) Provisional application No. 63/471,668, filed on Jun. 7, 2023.

(51) Int. Cl. H04L 9/06

(52) U.S. Cl. CPC H04L 9/0643; H04L 2209/122; H04L 2209/56

(57) ABSTRACT

Dynamically calculating an optimal operational efficiency configuration of a plurality of digital currency mining systems based on trending information related to the digital currency and extrinsic factors affecting the plurality of digital currency mining. The plurality of digital currency mining systems are sent configuration settings to achieve the optimal operational efficiency configuration.

### CROSS-REFERENCE TO RELATED APPLICATIONS

This application claims priority to Provisional Appl. No. 63/471,668 filed Jun. 7, 2023, the entire contents of the aforementioned are hereby incorporated by reference as if fully set forth herein, under 35 U.S.C. § 120.

### TECHNICAL FIELD

Embodiments relate generally to improving computer system performance, and, more specifically, to improving the performance of bitcoin mining systems.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Bitcoin mining is an energy intensive task. The profitability of bitcoin mining depends on various factors such as the block reward (in number of bitcoins), transaction fees, bitcoin price, energy efficiency, cost of energy, the global hash rate, etc. Also, bitcoin mining performed at an industrial scale needs to comply with constantly varying energy supply-demand scenarios, e.g., during phases of large public energy demand, bitcoin mining activities should ramp down, and similarly during low energy demand scenarios, energy is usually available at a lower cost and bitcoin mining can consume excess energy by increasing hardware throughput.

### BRIEF DESCRIPTION OF DRAWINGS

The present invention is illustrated by way of example, and not by way of limitation, in the figures of the accompanying drawings and in which like reference numerals refer to similar elements and in which:

FIG. 1 illustrates a bitcoin mining environment, according to an embodiment;

FIG. 2 illustrates a bitcoin mining system, according to an embodiment;

FIG. 3 illustrates an example of a profitability curve, according to an embodiment;

FIG. 4 illustrates a bitcoin mining environment, according to an embodiment; and

FIG. 5 is block diagram of a computer system upon which embodiments of the invention may be implemented.

### DETAILED DESCRIPTION OF THE INVENTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:
1.0. General Overview
2.0. System Architecture
3.0. Implementation Mechanism-Hardware Overview
4.0. Extensions and Alternatives

### 1.0. GENERAL OVERVIEW

This overview presents a basic description of some aspects of a possible embodiment of the present invention. It should be noted that this overview is not an extensive or exhaustive summary of aspects of the possible embodiment. Moreover, it should be noted that this overview is not intended to be understood as identifying any particularly significant aspects or elements of the possible embodiment, nor as delineating any scope of the possible embodiment in particular, nor the invention in general. This overview merely presents some concepts that relate to the example possible embodiment in a condensed and simplified format and should be understood as merely a conceptual prelude to a more detailed description of example possible embodiments that follows below.

Currently, in order to adjust the parameters of bitcoin mining hardware to attempt to balance energy efficiency with higher throughput, the systems require the user to manually intervene with system operations to implement changes to the voltage and frequency of the mining chips. The user must then reboot the system in order to achieve the new operating characteristics. This is a lengthy, time-consuming process (e.g., >15 minutes) and often leads to a loss in revenue generation during this phase. Frequent reboots also degrade system lifespan which negatively affects return-on-investment. This also impacts the ability to quickly alter energy usage to comply with energy supply-demand fluctuations, sometimes referred to as demand response. This leads to severe underutilization of mining hardware resources during the times of fluctuating energy demand. It also results in suboptimal responses to consumer or other industrial demand for energy. Current bitcoin mining hardware implementations do not allow for the dynamic tuning of hardware parameters, nor do they provide an efficient application programming interface (API) to higher level software to change the operating point on-the-fly.

In an embodiment, a hardware solution (both chip-level and system-level) is implemented with relevant management capabilities exposed as APIs such that the characteristics of each mining system can be tuned dynamically and at runtime.

In an embodiment, bitcoin mining hardware has the ability to trade-off energy efficiency for higher throughput. The system has the ability to dynamically tune the bitcoin mining hardware to operate at the optimal point in the energy efficiency-throughput curve.

### 2.0. SYSTEM ARCHITECTURE

In an embodiment, a digital currency mining environment is implemented. Individual mining system performance and efficiency are improved as well as overall mining facility operational efficiency. In an embodiment, two novel features are implemented in a bitcoin mining hardware environment: EnergyTune and AutoTune.

### EnergyTune:

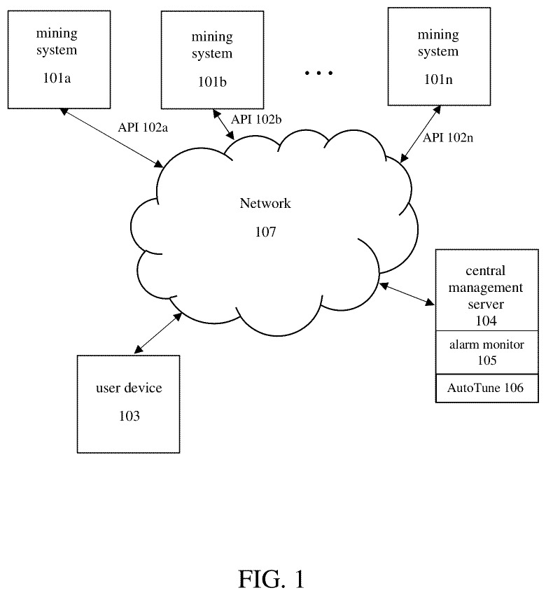

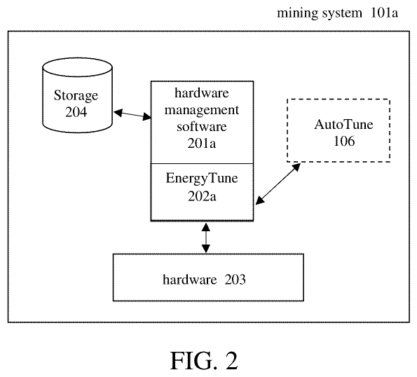

Referring to FIGS. 1 and 2, EnergyTune 202a provides a user and/or system manager with the capability to alter the operating characteristics of a bitcoin mining system 101a. In an embodiment, bitcoin mining hardware 203 is able to trade-off energy efficiency for throughput. The bitcoin mining system 101a can be run at a lower energy efficiency when it is running at a higher throughput (click frequency). Higher energy efficiency can be achieved when the bitcoin mining system 101a is running at a lower throughput. To enable this, the bitcoin mining system 101a includes novel features at the chip and the system level.

At the hardware level 203, the ASICs are designed such that the voltage and the PLL frequency of the chip can be changed during runtime without any disruption in operation (this can be configured on the fly via the hardware management software (HMS) 201a or directly through EnergyTune 202a). in an embodiment, HMS 201a provides user and system interface facilities for EnergyTune 202a which is a component of HMS 201a. A control register in the ASICs allows the ASIC hashing frequency to be changed dynamically by HMS 201a. A control register update/change does not interrupt the hashing operations and the ASIC continues operations seamlessly with the new hashing frequency value from the control register. At a system level, the power supply and the hashboard (including power traces, decoupling capacitors, etc.) in hardware 203 are designed in such a way that the power and throughput of the system can be changed without any disruption in system operation. HMS 201a provides an API 102a where the user or management system can input the desired energy-efficiency, throughput, and/or the maximum power of the system. EnergyTune 202a determines proper configuration parameters to achieve the user or management system settings and sends the configuration parameters to HMS 201a. HMS 201a calculates the proper values to be written to the control registers given the configuration parameters and configures hardware 203 by writing the values to the appropriate control registers.

HMS 201a allows the user to select a target hash rate and/or a desired power level via a user interface accessed directly through the HMS 201a (e.g., local access, remote access, etc.) or through the API 102a. EnergyTune 202a calculates configuration parameters to adjust the frequency and/or voltage on the hashboard or the power supply to meet the user's objective(s). For example, if the user selects hash rate, EnergyTune 202a meets the target hash rate by determining the configuration parameters for the ASIC(s) on the hashboard for the hash rate and then further optimizes the system to use the least amount of power needed to achieve the target hash rate by calculating the appropriate power level of the power supply and determining the configuration parameters for the power supply. HMS 201a calculates the values for the control registers for the ASIC(s) and the power supply corresponding to the configuration parameters and writes the values to the control registers. In another example, if the user selects a power level, EnergyTune 202a reaches that target power level by determining the corresponding configuration parameters for the power supply and then further optimizes the system to deliver the highest possible hash rate at that power level by calculating the highest possible hash rate for the target power level and determining the corresponding configuration parameters for the ASIC(s) on the hashboard. HMS 201a calculates the corresponding values for the control register on the ASIC(s) and the power supply then configures the ASIC(s) and power supply using the control registers.

EnergyTune 202a tunes the voltage and frequency of every chip in hardware 203 in the bitcoin mining system 101a to reach the user provided metric(s). EnergyTune 202a chooses the supply voltage and frequencies of all the chips such that energy efficiency is maximized under a given throughput and/or power budget(s) or throughput is maximized given an energy efficiency target. In an embodiment, the optimal efficiency is derived empirically by lowering the voltage until a hit rate of, for example, 97% is achieved, which is a determined maximum efficiency point of a particular hardware implementation (this can vary based on differing hardware implementations). In this example, increasing the voltage to get a hit rate above 97% may cause the system to use more energy percentage-wise than the percentage gain in hash rate obtained. Decreasing the voltage to get a hit rate below 97% may cause a loss of more hash rate percentage-wise than is gained in percentage of energy saved.

The API 102a can be used by higher level fleet management or data center management software in a central management server 104 across a network 107 (e.g., Internet, intranet, etc.) to optimize fleetwide operational metrics across a plurality of bitcoin mining systems 101a-101n as well as quickly and automatically respond to fluctuating energy costs and curtailment events. HMS 201a can also provide a graphical user interface (GUI) based interface to the user device 103, where the user can, for example, select which metric (e.g., throughput, efficiency, total power, etc.) to use and a slider to select the value of the metric.

This is particularly useful when energy availability fluctuates often. During periods of low energy availability, the HMS 201a can be set to a low throughput or low power value, and the hardware 203 adapts to the new operating conditions during runtime. Because Energy Tune 202a has the ability to optimize energy efficiency under any throughput or power constraint, users can maximize revenues under these constraints.

This is in stark contrast to today's bitcoin mining hardware implementations where long latencies for system tuning forces users to quickly turn off systems and often they run a subset of the systems at a suboptimal energy-throughput operating point. In fact, this long latency for system tuning and rebooting also inhibits users from turning on systems if energy availability spikes for a short duration. EnergyTune 202a solves this problem by improving the utilization and performance of bitcoin mining systems and increasing the efficiency of overall fleetwide operations. It provides full flexibility to the users to maximize system performance while maximizing mining efficiency and complying with energy availability and its associated constraints.

In an embodiment, EnergyTune 202a also allows the user to specify the duration of ramp-up and ramp-down of energy. In an embodiment, the system implements ramp up and down in minutes and seconds. In an example, the minimum time can be set by the user to 10 seconds and maximum can be set by the user to 900 seconds. This can ensure that sudden power draw changes do not impact stability of the power distribution network and the electricity grid. Having an entire site ramp-up at the same time could cause shutdowns because of power drops. This is not a problem with current bitcoin mining hardware systems because the user must configure each system manually and wait for the system to reboot. The long delays ensure that no sudden power changes occur. The embodiment not only improves the performance of the computer systems by ensuring the smooth ramp-up or ramp-down of each system, it also improves the technology by making it more efficient to configure multiple systems simultaneously during runtime and ensure safe ramp-ups or ramp-downs of power fleetwide. Additionally, when a system reboots, it creates a power spike as the system powers up all of its components. The embodiment eliminates that problem by not having to reboot systems, thus power consumption increases and decreases across the entire system are linear. In an embodiment, EnergyTune 202a also periodically scans the system and chip junction temperature in hardware 203 and adapts the operating condition to hit the required metrics. Energy Tune 202a monitors the hit rate percentage, and for the example above, lowers the voltage if the hit rate goes above 98% or raises the voltage if the hit rate goes below 96% in an effort to maintain a steady target hash rate. Increases in ambient temperature can cause the chips to get hotter and the hit rate to increase, while temperature decreases can cause chips to get cooler and the hit rate to decrease.

In addition to voltage control, EnergyTune 20a2 uses fan control to keep chip temperatures around, for example, 55 degrees Celsius, when possible, because the chips run at maximum efficiency at this temperature. EnergyTune 202a receives temperature parameters/ranges from HMS 201a which may be sent by a user, central management server 104, etc. In an embodiment, EnergyTune 202a uses the average system chip temperature as well as the highest system chip temperature as part of a weighted algorithm to determine the proper fan speed. In an example, fans can be set to rotate between 20%-100% of maximum RPM. For example, in a weighted algorithm:
err: =(avg_temp-my.systeminfo.optimal_temp)*0.5
err+=float32(math.Max(0,float64((max_temp-my.systeminfo.optimal_temp-10)*0.5)))
proportional: =err*0.05//a 20 C delta will change the fan 100%
my.fan_integral+=err*0.5
if my.fan_integral>100.0 {my.fan_integral=100.0}
if my.fan_integral<−10.0 {my.fan_integral=−10.0}
new_fan_percentage: =proportional+my.fan_integral*0.01
new_fan_percentage=float32 (math.Max (float64 (my.systeminfo.min_fan_percentage), float64 (new_fan_percentage))) new_fan_percentage=float32 (math.Min (1.0, float64 (new_fan_percentage)))
if max_temp>=my.systeminfo.max_junction_temp {
   new_fan_percentage=1.0
   my.fan_integral=100.0
   }
SetFans (new_fan_percentage)

In an embodiment, EnergyTune 202a can monitor external temperature measurements (e.g., outside of the bitcoin mining system 101a enclosure from one or more sensors in hardware 203 configured to monitor temperatures outside of the enclosure, room temperature from one or more external sensors communicatively connected to hardware 203 via wired or wireless (e.g., USB, Bluetooth, WiFi, etc.), within the rack of a rack mounted system that the bitcoin mining system 101a may be mounted in, from one or more sensors mounted in the rack communicatively connected to hardware 203 via wired or wireless (e.g., USB, Bluetooth, WiFi, etc.), etc.) and internal ASIC/board(s)/case temperatures from ASIC/board/case registers/sensors (e.g., chip temperature monitor(s), PCB temperature monitors, junction temperature monitor(s), hashing board temperature monitor(s), etc.) in hardware 203. The bitcoin mining system 101a can have a plurality of cooling fans mounted in the enclosure of the bitcoin mining system 101a. Each of the plurality of cooling fans are individually controllable by EnergyTune 202a. EnergyTune 202a can use the external and internal temperature measurement(s) to determine whether one or more of the cooling fans are to be activated/deactivated, speed setting of activated fans, etc., in order to achieve the temperature parameters/ranges received from the HMS 201a. The number of fans that are activated and the speed that they are set to by Energy Tune 202a in combination with external and internal temperature measurement(s) directly affect the system and chip junction temperature in hardware 203 in addition to energy consumption. For example, if the external room temperature is very cold, then the amount of cold air in the room brought into the bitcoin mining system 101a directly affects the system and chip junction temperature in hardware 203. EnergyTune 202a makes the system more efficient in its use of available energy.

In an embodiment, EnergyTune 202a can monitor the power supply unit (PSU) in the bitcoin mining system 101a enclosure. EnergyTune 202a can adjust the power supplied by the PSU. Using the PSU adjustment, EnergyTune 202a can adjust the amount of energy drawn by the PSU to further adjust for overall energy usage and internal enclosure temperature (the PSU drawing too much power emits some of its excess heat as a byproduct into the enclosure thereby increasing the internal enclosure temperature and affecting all internal components). EnergyTune 202a can calculate the amount of energy needed to power the motherboard, solid state drives (SSDs), fans and any other internal components, efficiency of the PSU at the desired power level (many PSUs are not as efficient under very low or high loads relative to the optimal load for the PSU), for example, and use the calculation to determine the level of energy required from the PSU. In the example above, this can be determined empirically by adjusting the hashboard voltage until the system reaches a hit rate of 97%. Note that, as discussed above, the target hit rate may be set by the user.

Each bitcoin mining system's performance may vary due to manufacturing processes, hardware variances, etc., and different ranges or thresholds may be sent for different systems. HMS 201a and EnergyTune 202a have the ability to store performance information locally 204 and can track performance trends in order to discover anomalous behavior. HMS 201 can also report system performance information to central management server 104. Anomalous behavior events and other issues such as a temperature range cannot be maintained or threshold is not met will result in HMS 201a and/or EnergyTune 202a generating an alarm event. Alarm events may be delivered in the GUI provided by HMS 201a or actively sent to a central reporting monitor 105.

An alarm event monitor 105 in a central management server 104 may be implemented to handle collection of alarm events from mining systems. In an embodiment, the alarm event monitor 105 can create reports for aggregate or individual alarm event types, notify administrator(s) of specific alarm conditions, etc.

### AutoTune:

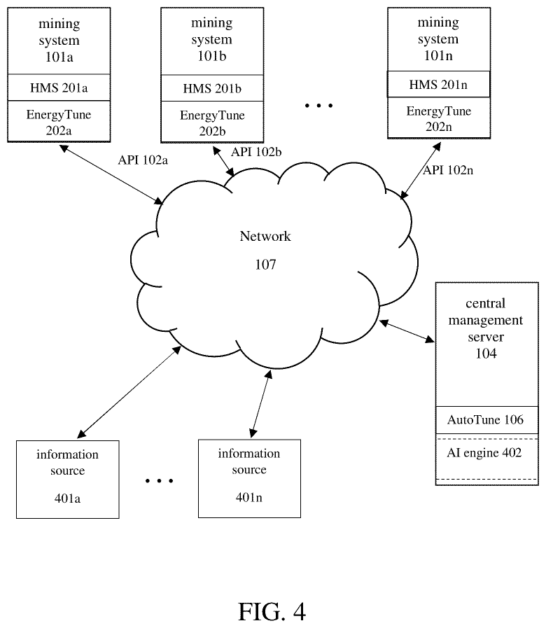

Referring to FIGS. 2 and 4, in an embodiment, AutoTune 106 can leverage EnergyTune 202a-202n to automatically maximize operational efficiency/throughput of bitcoin mining systems 101a-101n which in return, increases the profitability of the entire facility. AutoTune 106 takes into account the block reward (in number of bitcoins, the block reward includes the block subsidy (number of bitcoins per block, e.g., 6.25 in 2023) and transaction fees (TxFees) paid by users), bitcoin (BTC) price, energy efficiency, cost of energy, the global hash rate (for BTC in this example) and other operational costs (see, for example, Equation 1).

#bitcoins per day=(((Subsidy+TxFees)*(System Throughput(TH/s))*86400 secs/day)/(difficulty*2**32))*(1−poolfee) Equation 1:

Revenue per day=#bitcoins per day*price (current or projected) per BTC

kWh per day=Σ(Energy Efficiency (J/TH)*System Throughput (TH/s))/1000

Energy cost=kWh per day*cost per kWh

Profit per day per system=Revenue per day-Energy Cost
where:
TH/s: Throughput in TeraHashes per second
difficulty: A measure of how many hashes (statistically) must be generated to find a valid solution to solve the next Bitcoin block and earn the mining reward. This is a dynamic parameter that adjusts to ensure that a new block is found on average every 10 minutes across all miners in a network.
poolfee: Mining fee charged by bitcoin mining pool.
J: Joules

As is evident from Equation 1, depending on the extrinsic factors such as block reward, global hash rate and cost of electricity, the hardware parameters such as system hash rate and its corresponding energy efficiency would dictate the system efficiency (generated currency value minus cost of operation which results in return on investment (ROI)/profit) that the system will generate. AutoTune 106 continuously monitors the extrinsic factors by periodically pulling the required data from information sources (e.g., trading sources, local power companies, etc.) across the Internet. Dynamic changes in extrinsic factors and mining system status can cause system performance goals to change, e.g., energy cost, power outages, BTC valuation, mining system outages, etc. AutoTune 106 dynamically adjusts the performance of the mining systems 101a-101n as the overall profit/operational efficiency of mining operations changes.

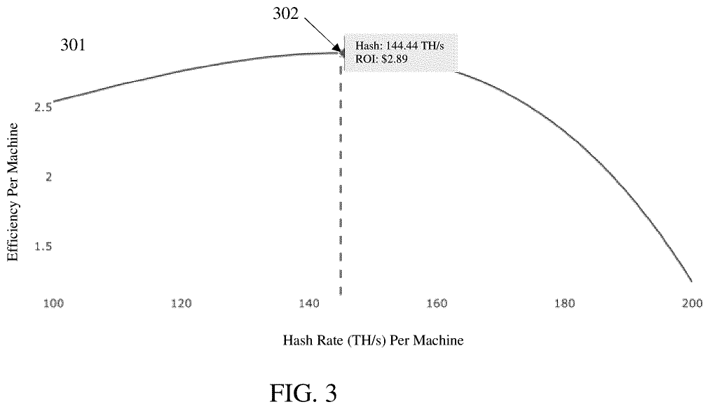

Referring to FIG. 3, an example of an operational efficiency/profitability curve 301 that AutoTune 106 explores is shown. The curve is plotted using current trending conditions for BTC and energy costs. AutoTune 106 obtains the extrinsic information from system parameter space and the mining systems data set to calculate and map the curve and find the optimal point 302 that maximizes system operational efficiency under the current extrinsic conditions and configures each system to the appropriate optimal settings using the HMS 201a-201n for each mining system 101a-101n. AutoTune 106 or the central management server 104 captures the BTC price, BTC Difficulty, and BTC Subsidy information from system parameter space using information sources 401a-401n that provide BTC trending information across network 107, e.g., the Internet, intranet, extranet, etc. AutoTune 106 calculates the system efficiency/profit for the data set that is prepared by AutoTune 106, central management server 104, a service provider server, etc., at different System Throughput (TH) and mining system efficiency points. AutoTune 106 calculates the optimal system efficiency that takes advantage of the operational efficiency curve 301, AutoTune 106 determines the optimal THs 302 among the mining systems 101a-101n (e.g., the maximum THs that are achievable by the mining systems 101a-101n in their current operational state) when adjusted for ROI/profitability per mining system and can adjust this value to each mining system 101a-101n. In an embodiment, since each mining system's operational efficiencies can vary, AutoTune 106 can calculate different configuration parameters for each mining system 101a-101n to reach optimal overall compliance with the optimal THs. AutoTune 106 communicates the configuration parameters to each HMS 201a-201n in the mining systems 101a-101n. EnergyTune 202a-202n in each mining system 101a-101n configures the mining system hardware to reach the configuration parameters.

HMS 201a-201n sends system performance information to AutoTune 106 in a feedback loop. AutoTune 106 uses the updated system performance information in its calculations for actual mining system TH and efficiency. In an embodiment, when AutoTune 106 detects changes in the extrinsic factors and/or the updated system performance information that affect the outcome of the optimal TH determination, AutoTune 106 can perform the tasks discussed above to dynamically react to the changing conditions. AutoTune 106 can also have the capability to comply with operating constraints such as maximum power. AutoTune 106 module may reside in the central management server 104 or in each mining system 101a-101n.

In an embodiment, AutoTune 106 may be augmented using an artificial intelligence (AI) engine 402. AI engine 402 is initially trained using an operational efficiency/profit curve such as 301 along with mining system operational data and other extrinsic data. The peak efficiency point of the curve and the mining system configuration parameters are examined and the system is retrained with updated data to correct any deficiencies. As the system operates in real-time, the feedback loop between AutoTune 106 and the EnergyTune 202a-202n modules in the mining systems 101a-101n allows for AI engine 402 to be retrained with updated system operational data as conditions change.

Note that although BTC is mentioned specifically in the above discussions and examples, any digital currency that requires mining systems can be improved using the material discussed herein.

In an embodiment, an apparatus comprises a processor and is configured to perform any of the foregoing methods.

In an embodiment, one or more non-transitory computer-readable storage media, storing software instructions, which when executed by one or more processors cause performance of any of the foregoing methods.

Although separate embodiments are discussed herein, any combination of embodiments and/or partial embodiments discussed herein may be combined to form further embodiments.

### 3.0. IMPLEMENTATION MECHANISMS-HARDWARE OVERVIEW

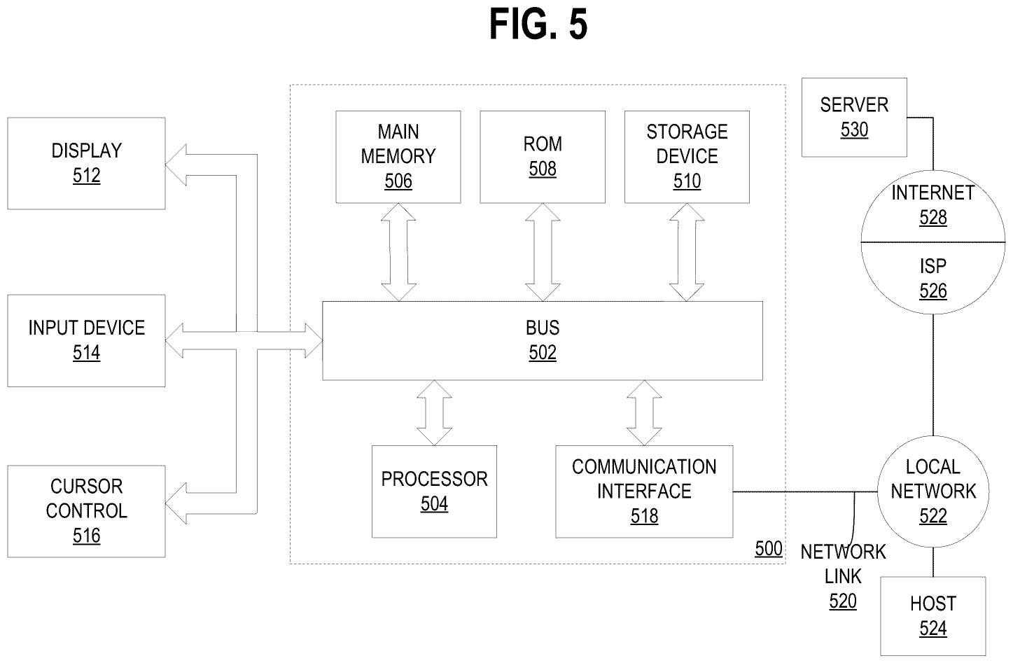

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is device-specific to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a liquid crystal display (LCD), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using device-specific hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 4.0. EXTENSIONS AND ALTERNATIVES

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the inventive subject matter have been described with reference to numerous specific details that may vary from implementation to implementation. Thus, the sole and exclusive indicator of what is the inventive subject matter, and is intended to be the inventive subject matter, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method comprising:
retrieving trending information for a digital currency across a network;
calculating an operational efficiency curve based on the trending information;
calculating an optimal point on the operational efficiency curve based on operating conditions across a plurality of digital currency mining systems that maximizes system operational efficiency across the plurality of digital currency mining systems;
determining system configuration settings for the plurality of digital currency mining systems based on the optimal point;
sending the system configuration settings to the plurality of digital currency mining systems.

2. The method of claim 1, wherein the determining system configuration settings further comprises:
calculating an optimal system hash rate corresponding to the optimal point;
determining system configuration settings for each digital currency mining system in the plurality of digital currency mining systems for the optimal system hash rate.

3. The method of claim 1, wherein the calculating the operational efficiency curve further comprises:
calculating points of the operational efficiency curve using the trending information and system throughput data of the plurality of digital currency mining systems.

4. The method of claim 1, wherein the calculating an optimal point further comprises:
determining a point on the operational efficiency curve that represents an optimal system hash rate and system efficiency value across the plurality of digital currency mining systems.

5. The method of claim 1, wherein the calculating an optimal point further comprises:
hash rate and system efficiency value across the plurality of digital currency mining systems, the system efficiency value incorporates a cost associated with operating a digital currency mining system.

6. The method of claim 1, wherein the digital currency is bitcoin.

7. The method of claim 1, further comprises:
wherein the retrieving trending information is performed periodically;
based on a determination that a change in the trending information affects the optimal point:
calculating an updated operational efficiency curve based on the trending information;
calculating an updated optimal point on the updated operational efficiency curve based on operating conditions across the plurality of digital currency mining systems that maximizes system operational efficiency across the plurality of digital currency mining systems;
determining updated system configuration settings for the plurality of digital currency mining systems based on the updated optimal point;
sending the updated system configuration settings to the plurality of digital currency mining systems.

8. The method of claim 1, further comprises:
receiving digital currency mining system operational data from the plurality of digital currency mining systems;
wherein the calculating an optimal point uses the operational data in the calculation of the optimal point on the operational efficiency curve.

9. One or more non-transitory computer-readable storage media, storing one or more sequences of instructions, which when executed by one or more processors cause performance of:
retrieving trending information for a digital currency across a network;
calculating an operational efficiency curve based on the trending information;
calculating an optimal point on the operational efficiency curve based on operating conditions across a plurality of digital currency mining systems that maximizes system operational efficiency across the plurality of digital currency mining systems;
determining system configuration settings for the plurality of digital currency mining systems based on the optimal point;
sending the system configuration settings to the plurality of digital currency mining systems.

10. The one or more non-transitory computer-readable storage media of claim 9, wherein the determining system configuration settings further comprises:
calculating an optimal system hash rate corresponding to the optimal point;
determining system configuration settings for each digital currency mining system in the plurality of digital currency mining systems for the optimal system hash rate.

11. The one or more non-transitory computer-readable storage media of claim 9, wherein the calculating the operational efficiency curve further comprises:
calculating points of the operational efficiency curve using the trending information and system throughput data of the plurality of digital currency mining systems.

12. The one or more non-transitory computer-readable storage media of claim 9, wherein the calculating an optimal point further comprises:
determining a point on the operational efficiency curve that represents an optimal system hash rate and system efficiency value across the plurality of digital currency mining systems.

13. The one or more non-transitory computer-readable storage media of claim 9, wherein the calculating an optimal point further comprises:
hash rate and system efficiency value across the plurality of digital currency mining systems, the system efficiency value incorporates a cost associated with operating a digital currency mining system.

14. The one or more non-transitory computer-readable storage media of claim 9, wherein the digital currency is bitcoin.

15. The one or more non-transitory computer-readable storage media of claim 9, wherein the one or more sequences of instructions, which when executed by one or more processors cause further performance of:
wherein the retrieving trending information is performed periodically;
based on a determination that a change in the trending information affects the optimal point:
calculating an updated operational efficiency curve based on the trending information;
calculating an updated optimal point on the updated operational efficiency curve based on operating conditions across the plurality of digital currency mining systems that maximizes system operational efficiency across the plurality of digital currency mining systems;
determining updated system configuration settings for the plurality of digital currency mining systems based on the updated optimal point;
sending the updated system configuration settings to the plurality of digital currency mining systems.

16. The one or more non-transitory computer-readable storage media of claim 9, wherein the one or more sequences of instructions, which when executed by one or more processors cause further performance of:
receiving digital currency mining system operational data from the plurality of digital currency mining systems;
wherein the calculating an optimal point uses the operational data in the calculation of the optimal point on the operational efficiency curve.

17. An apparatus comprising:
one or more processors; and
a memory storing instructions, which when executed by the one or more processors, cause the one or more processors to perform:
retrieving trending information for a digital currency across a network;
calculating an operational efficiency curve based on the trending information;
calculating an optimal point on the operational efficiency curve based on operating conditions across a plurality of digital currency mining systems that maximizes system operational efficiency across the plurality of digital currency mining systems;
determining system configuration settings for the plurality of digital currency mining systems based on the optimal point;
sending the system configuration settings to the plurality of digital currency mining systems.

18. The apparatus of claim 17, wherein the determining system configuration settings further comprises:
calculating an optimal system hash rate corresponding to the optimal point;
determining system configuration settings for each digital currency mining system in the plurality of digital currency mining systems for the optimal system hash rate.

19. The apparatus of claim 17, wherein the calculating the operational efficiency curve further comprises:
calculating points of the operational efficiency curve using the trending information and system throughput data of the plurality of digital currency mining systems.

20. The apparatus of claim 17, wherein the calculating an optimal point further comprises:
hash rate and system efficiency value across the plurality of digital currency mining systems, the system efficiency value incorporates a cost associated with operating a digital currency mining system.
